(19) United States
(12) Patent Application Publication
(10) Pub. No.: US 2006/0062660 A1
(43) Pub. Date: Mar. 23, 2006

(54) Apparatus for loading and unloading of a container upon a roll-off vehicle including a movable frame section

(76) Inventors: Lazar Marmur, Plainsboro, NJ (US); Gregory Krasnopolskiy, Trenton, NJ (US)

Correspondence Address: SPERRY ZODA AND KANE;SUITE D, ONE HIGHGATE DRIVE, TRENTON, NJ, 08618, US

(21) Appl. No.: 10/947,779

(22) Filed: Sep. 23, 2004

(51) Int. Cl. B60P 1/64

(52) U.S. Cl. 414/498

(57) ABSTRACT

An apparatus for powering the movement of a container such as a waste container onto and off of a roll-off vehicle such as a roll-off truck body or roll-off trailer including a movable frame section with a movable frontal section which moves simultaneously with loading and or unloading of the container on the roll-off vehicle. At least one shoe is utilized which initially powers movement of the container toward the mounting surface on the frame and during the latter stages of this movement also powers movement of the movable frontal section and the movable tail in those configurations where it is included.

### BACKGROUND OF THE INVENTION

1. Field of the Invention

The present invention deals with the field of various constructions used with roll-off trailers and roll-off truck bodies to facilitate loading and unloading of containers such as waste containers upon said vehicles. It is preferable that a movable frontal frame section is included which is slidable, or otherwise movable, relative to a stationary frame section to facilitate powering of loading and unloading. A tail section can be utilized that is stationary relative to the fixed frame or is movable with respect thereto. If movable, the tail section can be movable along with the movable frontal frame section by being secured thereto or formed integral therewith or the tail section can be movable independently from the movable frontal frame section. It is also preferable with such vehicles that the supporting surface can be tilted to facilitate loading and/or unloading with the inclusion of a tail extension extendable rearwardly selectively to facilitate the initial stages of loading particularly. Manually movable frame sections have been designed which are manually deployed. However, the present invention includes means for deploying and retracting of a slidable or movable frame section by the same powering means utilized for loading and unloading of the container with respect to the support surface of the roll-off vehicle.

2. Description of the Prior Art

A number of prior art devices have been utilized for various types of apparatus including uniquely designed frame constructions for facilitating the loading and unloading of containers with respect to roll back vehicles such as truck bodies and trailers. Examples of such patents include U.S. Pat. No. 1,821,327 patented Sep. 1, 1931 to W. P. Scott on an “Automobile Truck”; and U.S. Pat. No. 2,468,502 patented Apr. 26, 1949 to E. Lisota on an “Actuating Device For Sliding Vehicle Beds; and U.S. Pat. No. 2,530,350 patented Nov. 14, 1950 to E. R. Ehlert on an “Unloader For Farm Vehicles” and assigned to Tipton Mfg. Co., Inc.; and U.S. Pat. No. 2,621,814 patented Dec. 16, 1952 to E. Lisota on an “Adjustable Tilting Bed for Trucks; and U.S. Pat. No. 2,703,658 patented Mar. 8, 1955 to C. S. Bazzell on a “Vehicle Convoy or Carrier With Adjustable Ramp”; and U.S. Pat. No. 2,741,383 patented Apr. 10, 1956 to J. T. Leckert on a “Self Unloading Vehicle” and assigned to Amos E. Heath and Robert F. Minton; and U.S. Pat. No. 3,001,825 patented Sep. 26, 1961 to W. D. Rouse on a “Tandem Dumping-Platform Truck”; and U.S. Pat. No. 3,049,378 patented Aug. 14, 1962 to F. E. Nelson on a “Self-Loading And Unloading Vehicle”; and U.S. Pat. No. 3,074,574 patented Jan. 22, 1963 to R. Prince on a “Truck Frame And Retractable Truck Bed”; and U.S. Pat. No. 3,077,278 patented Feb. 12, 1963 to H. G. Alexander on a “Truck Loading Assembly With Detachable Container”; and U.S. Pat. No. 3,138,276 patented Jun. 23, 1964 to D. E. Allen et al on a “Demountable Truck Body”; and U.S. Pat. No. 3,144,149 patented Aug. 11, 1964 to G. R. Dempster et al on a “Transporting Equipment For Containers” and assigned to Dempster Brothers, Inc.; and U.S. Pat. No. 3,195,749 patented Jul. 20, 1965 to J. S. Dempster et al on a “Container Loading and Unloading Mechanism” and assigned to Dempster Brothers, Inc.; and U.S. Pat. No. 3,214,046 patented Oct. 26, 1965 to G. R. Dempster et al on a “Container Handling Mechanism” and assigned to Dempster Brothers, Inc.; and U.S. Pat. No. 3,231,120 patented Jan. 25, 1966 to G. R. Dempster et al on a “Container Loading And Unloading Mechanism” and assigned to Dempster Brothers, Inc.; and U.S. Pat. No. 3,272,546 patented Sep. 13, 1966 to C. R. Cooley on a “Push-Pull Device For Containers” and assigned to Tri-City Industrial Service, Inc.; and U.S. Pat. No. 3,302,808 patented Feb. 7, 1967 to W. A. Herpich et al on a “Container Loading And Unloading Mechanism”; and U.S. Pat. No. 3,399,795 patented Sep. 3, 1968 to R. V. Clucker et al on a “Loading Apparatus For Demountable Vehicle Bodies” and assigned to Harsco Corporation; and U.S. Pat. No. 3,467,268 patented Sep. 16, 1969 to A. Corompt on an “Apparatus For Handling And Transport Of Heavy Bulky Containers” and assigned to Etablissements Bennes Marrel; and U.S. Pat. No. 3,514,000 patented May 26, 1970 to M. C. Kolling et al on “Mobile Trucking Equipment”; and U.S. Pat. No. 3,572,563 patented Mar. 30, 1971 to Emerson T. Oliver on a “Truck Unloader”; and U.S. Pat. No. 3,606,059 patented Sep. 20, 1971 to H. Haberle, Jr. on a “Roll-Off Trailer”; and U.S. Pat. No. 3,638,817 patented Feb. 1, 1972 to Antoine Corompt on a “Container Handling And Transporting Device” and assigned to Bennes Marrel; and U.S. Pat. No. 3,648,868 patented Mar. 14, 1972 to Max M. Richler on a “Container Transporting Vehicle” and assigned to Atlas Hoist & Body Incorporated; and U.S. Pat. No. 3,712,491 patented Jan. 23, 1973 to Thomas P. Kreutzer on a “Dual Purpose Dump And Transport Vehicle” and assigned to L.S.T. Enterprises; and U.S. Pat. No. 3,819,075 patented Jun. 25, 1974 to Christian Derain on a “Device For Loading A Skip On To A Vehicle” and assigned to Societe Nouvelle des Bennes Saphem; and U.S. Pat. No. 3,874,537 patented Apr. 1, 1975 to Jean Kou on a “Road Vehicle Of The Platform Type”; and U.S. Pat. No. 3,892,323 patented Jul. 1, 1975 to Antoine Corompt on a “Container-Handling Device For A Self-Loading Vehicle” and assigned to Bennes Marrel; and U.S. Pat. No. 3,894,644 patented Jul. 15, 1975 to Harold G. Alexander on a “Truck-Mounted Loader”; and U.S. Pat. No. 3,934,740 patented Jan. 27, 1976 to James A. Rumell on a “Transport Vehicle With Tiltable Chassis”; and U.S. Pat. No. 3,964,626 patented Jun. 22, 1976 to Jose Luis Loidi Arregui on a “Truck For Handling Containers” and assigned to Asteko S/A; and U.S. Pat. No. 3,988,035 patented Oct. 26, 1976 to Antoine Corompt on a “Locking Device, In Particular For A Handling Cranked Arm Mounted On A Vehicle” and assigned to Bennes Marrel; and U.S. Pat. No. 4,058,231 patented Nov. 15, 1977 to Heikki Visa et al on an “Apparatus For Moving An Exchangeable Platform Or A Container On To And Off Of A Tipping Frame Of A Lorry, Trailer, Or The Like” and assigned to Autolava Oy; and U.S. Pat. No. 4,090,623 patented May 23, 1978 to Gustave Maurice Noyon on a “System For Handling A Container” and assigned to Societe Internationale d'Investissements et de Participations par abreviation Interpar; and U.S. Pat. No. 4,092,755 patented Jun. 6, 1978 to Gary W. Hughes on a “Highly Versatile Dock Trailer”; and U.S. Pat. No. 4,109,810 patented Aug. 29, 1978 to Eldon D. Jones on an “Apparatus For Mounting And Demounting A Vehicle Body”; and U.S. Pat. No. 4,133,439 patented Jan. 9, 1979 to Paul I. Goranson on a “Vehicle Body Loading And Unloading Mechanism” and assigned to Carrier Corporation; and U.S. Pat. No. 4,175,904 patented Nov. 27, 1979 to Markkn Airaksinen on an “Apparatus For Mounting, Demounting, and Tipping Vehicles” and assigned to Multilift Oy; and U.S. Pat. No. 4,225,280 patented Sep. 30, 1980 to Roger Brunet et al on a “Trailer For Transporting And Launching Floating Box Caissons” and assigned to Constructions Navales et Industrielles de la Mediterranee; and U.S. Pat. No. 4,344,731 patented Aug. 17, 1982 to Heikki Visa on “Equipment For Raising An Exchange Platform Or Container To A Horizontal Position Above The Level Of The Transport Position” and assigned to Oy Partek AB; and U.S. Pat. No. 4,350,469 patented Sep. 21, 1982 to Antoine Corompt on a “Handling Device Mounted On A Vehicle To Carry Out The Handling Of Loads Such As Skips And Containers” and assigned to Bennes Marrel S. A.; and U.S. Pat. No. 4,352,625 patented Oct. 5, 1982 to Jack Bolderoff on a “Container Handling Apparatus”; and U.S. Pat. No. 4,409,903 patented Oct. 18, 1983 to Tore C. Wilhelmsson et al on a “Transportation Apparatus”; and U.S. Pat. No. 4,453,878 patented Jun. 12, 1984 to Teuvo Paukku on a “Lock Device For Loading Equipment” and assigned to O Y Partek A B; and U.S. Pat. No. 4,455,118 patented Jun. 19, 1984 to Heino W. Scharf on an “Opposed Cylinder Cable Hoist Mechanism” and assigned to Dempster Systems Inc.; and U.S. Pat. No. 4,514,131 patented Apr. 30, 1985 to James P. Godwin, Sr. on an “Automatic Self-Locking Roll Back Carrier For A Vehicle”; and U.S. Pat. No. 4,529,349 patented Jul. 16, 1985 to Theodore A. Lutz on a “Roll-Off Hoist”; and U.S. Pat. No. 4,580,805 patented Apr. 8, 1986 to William A. Bertolini on an “Extendable Container Chassis For Trucks” and assigned to Titan, Inc.; and U.S. Pat. No. 4,548,541 patented Oct. 22, 1985 to Antoine Corompt on a “Method And Apparatus For Unloading A Piece of Equipment Placed On A Carrying Vehicle” and assigned to Bennes Marrel; and U.S. Pat. No. 4,599,040 patented Jul. 8, 1986 to Robert Rasmussen on a “Method For Transporting Containers” and assigned to Accurate Industries, Inc.; and U.S. Pat. No. 4,645,405 patented Feb. 24, 1987 to Angelo M. Cambiano on a “Roll-Off Container Handling Mechanism”; and U.S. Pat. No. 4,704,063 patented Nov. 3, 1987 to Elbert B. Updike, Jr. et al on a “Container Loading And Unloading Apparatus”; and U.S. Pat. No. 4,755,097 patented Jul. 5, 1988 to Antoine Cotompt on a “Device For The Handling And Transfer Of A Load On A Vehicle Such As A Container Or A Tray” and assigned to Bennes Marrel; and U.S. Pat. No. 4,762,370 patented Aug. 9, 1988 to Antoine Corompt et al on a “Tipping Device To Control The Tipping Of A Body Mounted On A Vehicle” and assigned to Bennes Marrel; and U.S. Pat. No. 4,802,811 patented Feb. 7, 1989 to Derk Nijenhuis on an “Apparatus For Loading And Unloading An Interchangeable Container Onto And From A Vehicle” and assigned to N.C.H. Hydraulische Systemen BV; and U.S. Pat. No. 4,836,735 patented Jun. 6, 1989 to Michael J. Dennehy, Jr. et al on a “Load Positioning Container Chassis” and assigned to XTRA Corporation; and U.S. Pat. No. 4,840,532 patented Jun. 20, 1989 to Donald E. Galbreath on a “Roll-Off Hoist For Variable Positioning Of Containers” and assigned to Galbreath Incorporated; and U.S. Pat. No. 4,848,619 patented Jul. 18, 1989 to Antoine Corompt on a “Device For The Handling Of A Container” and assigned to Bennes Marrel; and U.S. Pat. No. 4,889,464 patented Dec. 26, 1989 to F. Wayne Self on a “Movable Tipping Frame For Hoist Trucks” and assigned to Translift Systems, Inc.; and U.S. Pat. No. 4,934,898 patented Jun. 19, 1990 to Donald E. Galbreath on a “Roll-Off Hoist For Variable Positioning Of Containers And Method For Use Thereof” and assigned to Galbreath Incorporated; and U.S. Pat. No. 4,943,203 patented Jul. 24, 1990 to John Bohata on a “Retriever Truck; and U.S. Pat. No. 4,954,039 patented Sep. 4, 1990 to William T. Johnston et al on a “Uniframe Rolloff Dumpster” and assigned to Trailstar Mfg. Corp.; and U.S. Pat. No. 4,986,719 patented Jan. 22, 1991 to Donald E. Galbreath on a “Roll-Off Hoist For Variable Positioning Of Containers” and assigned to Galbreath Incorporated; and U.S. Pat. No. 5,007,791 patented Apr. 16, 1991 to T. Trafford Boughton on an “ISO Container Handling System” and assigned to T. T. Broughton & Sons Ltd.; and U.S. Pat. No. 5,026,228 patented Jun. 25, 1991 to P. Michael Mansfield on a “Truck Trailer With Hydraulic Cargo Container Positioning Mechanism”; and U.S. Pat. No. 5,082,416 patented Jan. 21, 1992 to Normann Bock on a “Method Of Picking Up And Depositing A Hollow Receptacle Such As A Bin, Container Or The Like By And On, Respectively, A Vehicle With Change Gear Mechanism; Change Gear Mechanism For Carrying Out The Method; And Receptacle Designed For Use In Such Method” and assigned to Edelhoff M.S.T.S. GmbH; and U.S. Pat. No. 5,088,875 patented Feb. 18, 1992 to Donald E. Galbreath et al on a “Roll-Off Hoist For Variable Positioning Of Containers” and assigned to Galbreath Incorporated; and U.S. Pat. No. 5,163,800 patented Nov. 17, 1992 to Reijo Raisio on a “Transportable Frame And Equipment Frame For Use With Load Handling System” and assigned to Multilift Oy; and U.S. Pat. No. 5,183,371 patented Feb. 2, 1993 to Harold W. O'Daniel on an “Extendable Rolloff Trailer”; and U.S. Pat. No. 5,203,668 patented Apr. 20, 1993 to Lazar Marmur on an “Apparatus For Loading And Unloading Of A Container Structure Or Other Loads With Respect To A Truck Body Or Trailer” and assigned to E. Fisher, L. Marmur, F. Fisher and W. Kimble; and U.S. Pat. No. 5,213,466 patented May 25, 1993 to Leslie Bubik on a “Multifunction Loading And Recovery Apparatus” and assigned to Vulcan International, Inc.; and U.S. Pat. No. 5,246,329 patented Sep. 21, 1993 to Richard J. Farrell on a “Multi-Position Flat Bed Truck”; and U.S. Pat. No. 5,246,330 patented Sep. 21, 1993 to Lazar Marmur et al on an “Apparatus For Loading And Unloading Of Two Separate Containers Upon A Vehicular Body” and assigned to Automated Waste Equipment Co.; and U.S. Pat. No. 5,324,160 patented Jun. 28, 1994 to Bud Smith on a “Tiltable Trailer For Loading, Unloading And Transporting Containers”; and U.S. Pat. No. 5,460,473 patented Oct. 24, 1995 to Robert LaMora et al on a “Double Container Trailer” and assigned to Accurate Industries, Inc.; and U.S. Pat. No. 5,509,775 patented Apr. 23, 1996 to Donald H. Kendall on a “Self Loading Cargo Vehicle” and assigned to The United States of America as represented by the Secretary of the Army; and U.S. Pat. No. 5,529,454 patented Jun. 25, 1996 to Stephen D. Alm et al on a “Transporting Apparatus and Method”; and U.S. Pat. No. 5,542,807 patented Aug. 6, 1966 to Kent Kruzick on a “Vehicle Mounted, Variable Length Hook Hoist” and assigned to Galbreath Incorporated; and U.S. Pat. No. 5,562,391 patented Oct. 8, 1996 to Richard Green on a “Modular Unit Loading And Unloading Apparatus”; and U.S. Pat. No. 5,580,211 patented Dec. 3, 1996 to William F. Mengel on a “Container Transportation System”; and U.S. Pat. No. 5,601,393 patented Feb. 11, 1997 to Thomas J. Waldschmitt on a “Dual Capacity Hook-Lift Hoist” and assigned to Swaokiader U.S.A., Ltd.; and U.S. Pat. No. 5,660,446 patented Aug. 26, 1997 to Edison Pernell Weatherly on a “Dump Trailer With Multi-Stage Hopper; and U.S. Pat. No. 5,662,453 patented Sep. 2, 1997 to Steven R. Gerstner et al on a “Truck Bed Lift System And Method”; and U.S. Pat. No. 5,678,978 patented Oct. 21, 1997 to Gary R. Markham on an “Apparatus For A Tiltable Rolloff Trailer Having A Displacable Frame” and assigned to Modern, Inc.; and U.S. Pat. No. 5,718,554 patented Feb. 17, 1998 to Johnny R. McElroy on a “Truck Trailer With Removable Racks” and assigned to The McElroy Company, Inc.; and U.S. Pat. No. 5,725,350 patented Mar. 10, 1998 to Ronald E. Christenson on a “Detachable Truck Body And Handling Mechanism” and assigned to McNeilus Truck And Manufacturing Inc.; and U.S. Pat. No. 5,795,124 patented Aug. 18, 1998 to Jerry J. Kitten et al on a “Self-Loading Material Hauler And Distributor” and assigned to Jerry J. Kitten; and U.S. Pat. No. 5,779,431 patented Jul. 14, 1998 to Stephen D. Alm et al on a “Transporting Apparatus And Method” and assigned to Vulcan International, Inc.; and U.S. Pat. No. 5,807,057 patented Sep. 15, 1998 to Derk Nijenhuis on a “Transport Vehicle For Taking Up and Taking Down Containers and the Like Onto Or From A Loading Platform Thereof” and assigned to N.C.H. Hydraulische Systemen B.V.; and U.S. Pat. No. 5,813,824 patented Sep. 29, 1998 to Jerald G. Zanzig et al on a “Method Of Collecting Refuse” and assigned to The Heil Company; and U.S. Pat. No. 5,823,733 patented Oct. 20, 1998 to Kent Kruzick on a “Vehicle Mounted Hoist With Adjustable Container Supporting Roller Assemblies”; and U.S. Pat. No. 5,839,864 patented Nov. 24, 1998 to Stephen Kenneth Reynard on a “Locking System For Container-Carrying Trailer; and U.S. Pat. No. 5,848,869 patented Dec. 15, 1998 to Alexander H. Slocum et al on a “Container Restraining Mechanism and Method” and assigned to AESOP, Inc.; and U.S. Pat. No. 5,871,328 patented Feb. 16, 1999 to Donald L. Pinkston on a “Wrecker Truck With Sliding Deck”; and U.S. Pat. No. 5,913,561 patented Jun. 22, 1999 to John William Alcorn on a “Top Cover “Trapping” System For Roll-Off Container Trucks”; and U.S. Pat. No. 5,921,742 patented Jul. 13, 1999 to Brian O. Gearhart on an “Articulating Roll-Off Trailer” and assigned to Benlee, Inc.; and U.S. Pat. No. 5,951,235 patented Sep. 14, 1999 to Charles E. Young et al on an “Advanced Rollback Wheel-Lift” and assigned to Jerr-Dan Corporation; and U.S. Pat. No. 5,967,733 patented Oct. 19, 1999 to Russell Cash on a “Hydraulic Tilt Trailer” and assigned to Cash Brothers Leasing, Inc.; and U.S. Pat. No. 5,996,171 patented Dec. 7, 1999 to Randy Bowers on a “Vacuum Truck System”; and U.S. Pat. No. 6,053,692 patented Apr. 25, 2000 to Thomas M. Mason et al on a “Device For Securing A Removable Container To A Hauling Vehicle”; and U.S. Pat. No. 6,068,440 patented May 30, 2000 to Allen M. Lang et al on a “Locking Mechanism For Roll-Off Hoist” and assigned to Marathon Equipment Company; and U.S. Pat. No. 6,168,371 patented Jan. 2, 2001 to Jerome R. Lesmeister et al on a “Method Of Loading A Container” and assigned to Raymond Keith Foster; and U.S. Pat. No. 6,276,890 patented Aug. 21, 2001 to Thomas A. Pratt on a “Carrier With Articulable Bed” and assigned to Miller Industries Towing Equipment, Inc.; and U.S. Pat. No. 6,332,746 patented Dec. 25, 2001 to Allen M. Lang et al on a “Locking Mechanism For Roll-Off Hoist” and assigned to Delaware Capital Formation, Inc.; and U.S. Pat. No. 6,336,783 patented Jan. 8, 2002 to Charles E. Young et al on an “Advanced Rollback Wheel-Lift” and assigned to Jerr-Dan Corporation; and U.S. Pat. No. 6,354,787 patented Mar. 12, 2002 to Harold W. O'Daniel on a “Double Container Trailer Apparatus And Method Of Use” and assigned to G & H Manufacturing Ltd.; and U.S. Pat. No. 6,394,734 patented May 28, 2002 to Donald R. Landoll et al on a “Trailer Having Actuatable Tail Ramp” and U.S. Pat. No. 6,406,231 patented Jun. 18, 2002 to Donald R. Landoll et al on a “Container Lockdown Device” and assigned to Landoll Corporation; and U.S. Pat. No. 6,406,247 patented Jun. 18, 2002 to Andre Ghiretti et al on an “Apparatus For Loading And Unloading A Container On To And Off A Vehicle” and assigned to Palfinger AG; and U.S. Pat. No. 6,419,292 patented Jul. 16, 2002 to Bill G. Calcote et al on a “Truck Bed Conversion”; and U.S. Pat. No. 6,431,577 patented Aug. 13, 2002 to Jeffrey L. Chapman on a “Trailer Hitch Support Body; and U.S. Pat. No. 6,461,096 patented Oct. 8, 2002 to Carl R. Mentele et al on a “Tilt Bed For Loading And Transporting A Load” and assigned to Trail King Industries, Inc.; and U.S. Pat. No. 6,511,278 patented Jan. 28, 2003 to Melanie W. Harkcom et al on an “Apparatus For Securing An Implement To A Transporter” and assigned to New Holland North America, Inc.; and U.S. Pat. No. 6,537,015 patented Mar. 25, 2003 to Dae-Woo Lim et al on a “Container Loading And Unloading Apparatus” and assigned to Kosman Co., Ltd.; and U.S. Pat. No. 6,547,506 patented Apr. 15, 2003 to Albert Kirk Jacob on a “Multi-Task Truck”; and U.S. Pat. No. 6,558,104 patented May 6, 2003 to James A. Vlaanderen et al on a “Container Handling System For A Vehicle” and assigned to Stellar Industries, Inc.; and U.S. Pat. No. 6,568,892 patented May 27, 2003 to Donald R. Landoll et al on a “Container Lockdown Device” and assigned to Landoll Corporation; and U.S. Pat. No. 6,589,005 patented Jul. 8, 2003 to Curtis Hull on a “Tilt Bed Trailer” and assigned to H & H Trailer Company, Inc.

### SUMMARY OF THE INVENTION

The present invention provides a unique apparatus with a movable frame section which is slidable to aid in loading and unloading of a container upon a roll-off vehicle. A tail section can be provided which is fixed with respect to the fixed frame portion or is movable with respect thereto independently from the movable frame section. Alternatively, a slidable tail section can also be included which will be retracted as well as deployed by the same powering device. This apparatus includes a frame with a stationary frame section mounted with respect to the roll-off vehicle which defines an upper support surface for receiving of a container thereupon. This stationary frame section also preferably will include an outer tubular section and an outer tubular channel defined longitudinally therewithin. The stationary frame preferably will include a stationary front end and a stationary tail end which is located longitudinally distant from the stationary front end.

A base crossmember will be mounted on the stationary frame section and extend laterally thereacross at a position between the stationary front end and the stationary tail end thereof. A first stationary frame rail will preferably extend longitudinally at least from the stationary front end to the stationary tail end. Similarly a second stationary frame rail will also extend longitudinally at least from the stationary front end to the stationary tail end and be spatially disposed laterally from the first frame rail to facilitate defining of a shoe containment zone therebetween.

A movable frame section will be included within the overall construction of the frame which is movably engaged with respect to the stationary frame section in order to be movable relative thereto longitudinally. This movable frame section will preferably be telescopically movable and in engagement with respect to the stationary frame section in order to facilitate relative longitudinal movement of the movable frame section with respect thereto. The movable frame section will also include an inner tubular construction which is adapted to extend into and through the outer tubular channel of the outer tubular means of the stationary frame to facilitate telescoping longitudinal relative movement between the movable frame section and the stationary frame section.

The movable frame section will include a movable frontal section including a frontal crossmember extending laterally thereacross at a position spatially disposed longitudinally forwardly from the base crossmember. The movable frontal section will also preferably be extendible longitudinally outwardly from the stationary front end of the stationary frame section.

Optionally, the movable frame section of the present invention will also possibly include a movable tail section extendible outwardly from the stationary tail end of the stationary frame section oppositely oriented longitudinally from the movable frontal section. In this alternative embodiment, the movable frame section itself will preferably be movable between a tail extended position with the movable tail section extending rearwardly from the stationary frame section to facilitate loading of the container upon the upper support surface and a tail retracted position with the movable tail section retracted from the extended position. The movable frontal section of the movable frame section will preferably be adapted to extend longitudinally forwardly from the stationary front end of the stationary frame section during movement of the movable frame section between the tail extended position and the tail retracted position.

This movable tail section of the movable frame section will also preferably be adapted to extend longitudinally rearwardly from the stationary tail end of the stationary frame section during movement of the movable frame section between the tail extended position and the tail retracted position. The movable frontal section of the movable frame section and the movable tail section of the movable frame section can be configured integrally as a single integrally formed part.

A shoe member is included movably engaged with respect to the stationary frame section and also attached to the movable frame section to be movable therewith. This shoe member is movable longitudinally between a shoe starting position and a shoe final position spatially disposed longitudinally with respect to one another and defining a shoe movement path therebetween. The shoe containment zone through which the shoe movement path extends is preferably defined laterally between the first stationary frame rail and the second stationary frame rail and is preferably defined longitudinally between the base crossmember and the frontal crossmember.

The apparatus of the present invention further includes a longitudinally extensible member which preferably comprises a hydraulic cylinder which is preferably pivotally attached with respect to the base crossmember and is adapted to extend outwardly therefrom longitudinally from the main frame. This hydraulic cylinder is also attached with respect to the shoe member and is operative to urge movement thereof longitudinally with respect to the main frame in a direction away from the base crossmember to an intermediate abutment position in abutting engagement with respect to the movable frame section of said movable frame. In the configurations utilizing the extendible tail section, the movable frame section will be powered by the longitudinally extensible member to move from the tail extended position to the tail retracted position while simultaneously pulling the container onto the upper support surface.

The intermediate abutment position is preferably located within the shoe movement path between the shoe starting position and the shoe final position. The movable frame section is preferably stationary with respect to the stationary frame section during movement of the shoe member from the shoe starting position to the shoe intermediate position. With the integral movable tail configuration, the movable frame section will also move from the tail extended position to the tail retracted position during movement of the shoe member from the shoe intermediate position to the shoe final position. The shoe member and the frontal crossmember are preferably in direct abutment with respect to one another responsive to the shoe member moving to the intermediate abutment position.

A base sheave is preferably defined rotatably mounted on the base crossmember. A shoe sheave is rotatably mounted with respect to the shoe member and movable therewith along the shoe movement path between the shoe starting position and the shoe final position. A frontal sheave is rotatably mounted with respect to the frontal crossmember and is movable therewith.

A flexible line or preferably metallic cable is secured with respect to the frame and extends outwardly therefrom around the shoe sheave and then around the base sheave and then around the frontal sheave and finally is attached to the container to facilitate loading thereof on the upper support surface of the roll-off vehicle. A locking mechanism may be included mounted on the movable frontal section of the movable frame section and also a locking engagement device may be mounted on the shoe member. The locking means and the locking engagement device are adapted to interlock with respect to one another responsive to abutting engagement of the shoe member with respect to the frontal section of the movable frame section at the intermediate shoe position to selectively maintain abutting engagement of the shoe member with respect to the frontal section of the movable frame section.

Preferably a lock disengagement device is also included which is operative to disengage the lock engagement means with respect to the locking means responsive to return movement of the shoe member to the shoe starting position.

Also the present invention will preferably include a frame tilt back or tilting means which is operative to tilt the frame angled down rearwardly by lifting of the stationary front end of the stationary frame section and lifting of the movable frontal section of the movable frame section upwardly to facilitate loading of a container upon the upper support surface.

It is an object of the present invention to provide an apparatus with a movable frame section for facilitating loading and unloading of a container upon a roll-off vehicle which has minimal maintenance requirements.

It is an object of the present invention to provide an apparatus with a movable frame section for facilitating loading and unloading of a container upon a roll-off vehicle which is of minimal capital costs.

It is an object of the present invention to provide an apparatus with a movable frame section for facilitating loading and unloading of a container upon a roll-off vehicle which can optionally be configured such as to simultaneously move an extendible tail and move a container upon the container mounting surface.

It is an object of the present invention to provide an apparatus with a movable frame section for facilitating loading and unloading of a container upon a roll-off vehicle which can be configured to power movement of a container onto a container mounting surface and allow retraction of an extendible tail section by a single powering unit.

It is an object of the present invention to provide an apparatus with a movable frame section for facilitating loading and unloading of a container upon a roll-off vehicle which can be configured to allow the use of an extendible tail section and does not require any additional powering means to facilitate retracting thereof.

It is an object of the present invention to provide an apparatus with a movable frame section for facilitating loading and unloading of a container upon a roll-off vehicle which can rapidly, efficiently and repeatedly load containers upon a roll-off trailer or truck body while simultaneously urging retraction of an extendible tail section.

### BRIEF DESCRIPTION OF THE DRAWINGS

While the invention is particularly pointed out and distinctly claimed in the concluding portions herein, a preferred embodiment is set forth in the following detailed description which may be best understood when read in connection with the accompanying drawings, in which:

FIG. 1A is a top plan view of an embodiment of the loading and unloading apparatus of the present invention shown in the initial starting position;

FIG. 1B is a side schematic view of an embodiment of the loading and unloading apparatus of the present invention shown in the initial starting position;

FIG. 1C is a side plan view of an embodiment of the loading and unloading apparatus of the present invention shown in the initial starting position;

FIG. 2A is a top plan view of an embodiment of the loading and unloading apparatus of the present invention shown in the initial stages of movement;

FIG. 2B is a side schematic view of an embodiment of the loading and unloading apparatus of the present invention shown in the initial stages of movement;

FIG. 2C is a side plan view of an embodiment of the loading and unloading apparatus of the present invention shown in the initial stages of movement;

FIG. 3A is a top plan view of an embodiment of the loading and unloading apparatus of the present invention shown at the intermediate stage of movement;

FIG. 3B is a side schematic view of an embodiment of the loading and unloading apparatus of the present invention shown at the intermediate stage of movement;

FIG. 3C is a side plan view of an embodiment of the loading and unloading apparatus of the present invention shown at the intermediate stage of movement;

FIG. 4A is a top plan view of an embodiment of the loading and unloading apparatus of the present invention shown at the last stages of movement;

FIG. 4B is a side schematic view of an embodiment of the loading and unloading apparatus of the present invention shown at the last stages of movement;

FIG. 4C is a side plan view of an embodiment of the loading and unloading apparatus of the present invention shown at the last stages of movement;

FIG. 5A is a top plan view of an embodiment of the loading and unloading apparatus of the present invention shown at the end of movement for loading;

FIG. 5B is a side schematic view of an embodiment of the loading and unloading apparatus of the present invention shown at the end of movement for loading;

FIG. 5C is a side plan view of an embodiment of the loading and unloading apparatus of the present invention shown at the end of movement for loading;

FIG. 6 is a side cross-sectional view of an embodiment of a frame for use with the apparatus of the present invention showing the tubular telescoping movable interconnection;

FIG. 7A is a side plan view of a vehicle loading a container shown at the point of initial loading;

FIG. 7B is an illustration of the embodiment shown in FIG. 7A illustrating the position after loading has been initiated;

FIG. 7C is an illustration of the embodiment shown in FIG. 7A wherein loading is approximately 50% completed;

FIG. 7D is an illustration of the embodiment shown in FIG. 7A wherein loading is almost completed;

FIG. 7E is an illustration of the embodiment shown in FIG. 7A wherein loading is in the final loaded position;

FIG. 8A is a top plan view of an embodiment of the apparatus of the present invention showing the movable frame section and shoe member moving toward one another prior to locking;

FIG. 8B is a side plan view of an embodiment of the apparatus of the present invention showing the movable frame section and shoe member moving toward one another prior to locking;

FIG. 9A is a top plan view of an embodiment of the apparatus of the present invention showing the movable frame section and shoe member immediately prior to locking engagement therebetween;

FIG. 9B is a side plan view of an embodiment of the apparatus of the present invention showing the movable frame section and shoe member immediately prior to locking engagement therebetween;

FIG. 10A is a top plan view of an embodiment of the apparatus of the present invention showing the movable frame section and shoe member after full locking engagement therebetween;

FIG. 10B is a side plan view of an embodiment of the apparatus of the present invention showing the movable frame section and shoe member after full locking engagement therebetween;

FIG. 11 is a cross-sectional view of an embodiment of the apparatus of the present invention;

FIG. 12A is a side plan view of an alternative embodiment of the loading and unloading apparatus of the present invention; and

FIG. 12B is top plan view of an alternative embodiment of the loading and unloading apparatus of the present invention.

### DETAILED DESCRIPTION OF THE PREFERRED EMBODIMENT

The present embodiment discloses a unique apparatus with a movable frame section which slides with respect to a stationary frame section which greatly facilitates the loading and unloading of a container 10 upon an upper support surface 20 defined on the frame 14 of a roll-off vehicle 12 such as a roll-off truck body or trailer body. This apparatus can include optionally a tail section movable along with the movable frame section and the movable frontal section thereof.

The frame 14 preferably includes a stationary frame section 22 which is fixedly secured with respect to the vehicle 12 and defines a stationary front end 28 and a stationary tail end 30. In the preferred configuration the stationary frame section 22 will also define a first stationary frame rail 32 and a second stationary frame rail 34 spaced apart from one another laterally and defining therebetween a shoe containment zone 36 for receiving a shoe member 64 movably mounted therebetween.

The stationary frame section 22 will preferably include a base crossmember 38 with a base sheave 82 mounted rotatably thereupon. Furthermore it is preferable that the stationary frame section 22 define an outer tubular means 24 which defines a longitudinally extending outer tubular channel 26 extending therethrough to facilitate telescopically movable interconnection with respect to the movable frame section 50.

For the purposes of the present invention the longitudinal direction is shown by longitudinal direction arrow 16 and the lateral direction is defined by lateral direction arrow 18.

In this embodiment the movable frame section 50 is shown included and being capable of moving in a forwardly and rearwardly direction with respect to the stationary frame section 22. In the preferred configuration the movable frame section 50 will include an inner tubular means 52 which is of a size small enough to fit within the outer tubular channel means 26 defined in the outer tubular means 24 of the stationary frame section 22 to allow telescoping longitudinal relative movement between the stationary frame section 22 and the movable frame section 50.

The movable frame section 50 includes a movable front section 54. This movable front section 54 is movable back and forth between a rear position 46 and a front position 48. Optionally, the movable frame section 50 can also include a movable tail section 58. In those embodiments where the movable tail section 58 is included along with the movable front section 54, these two parts are formed as a single integral frame formed as a unit and defined as the movable frame section 50. Alternatively, the tail section can be independently movable from the movable front section or the tail section can be fixed to the fixed frame. A frontal crossmember 56 will be included preferably secured to the movable frontal section 54 of the movable frame section 50.

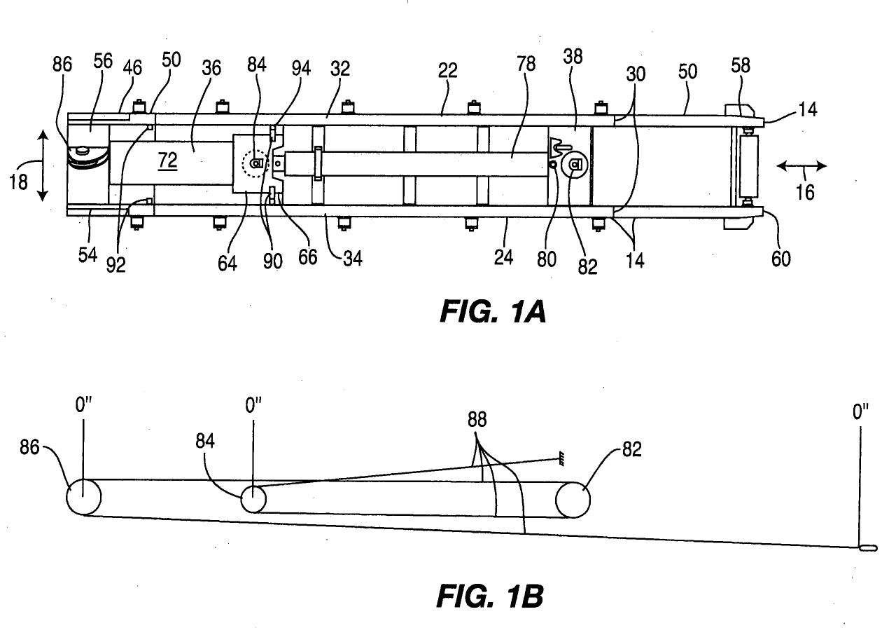

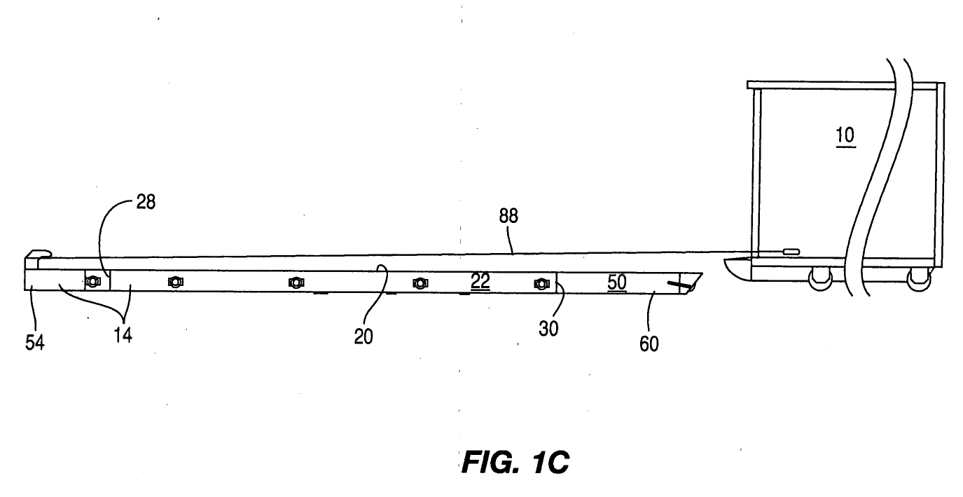

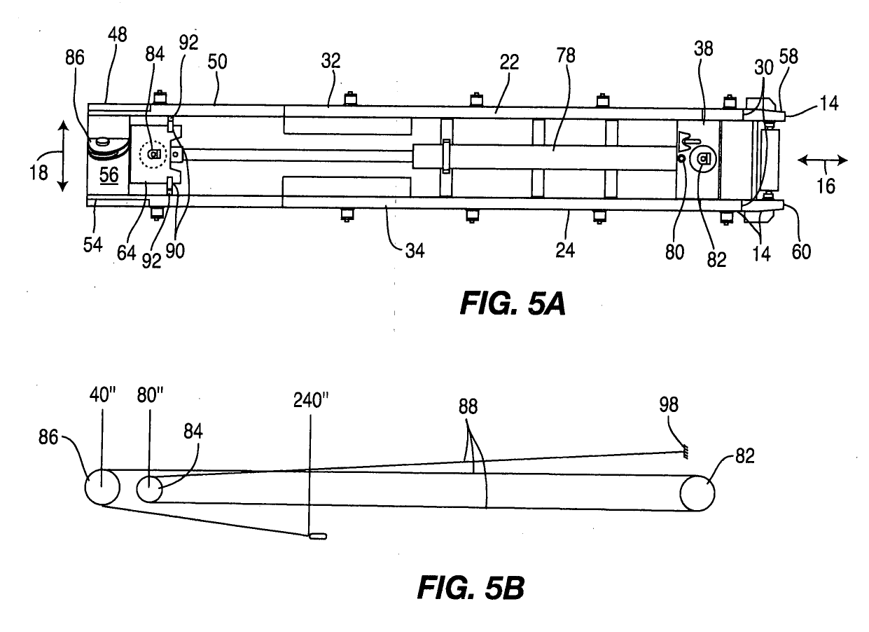

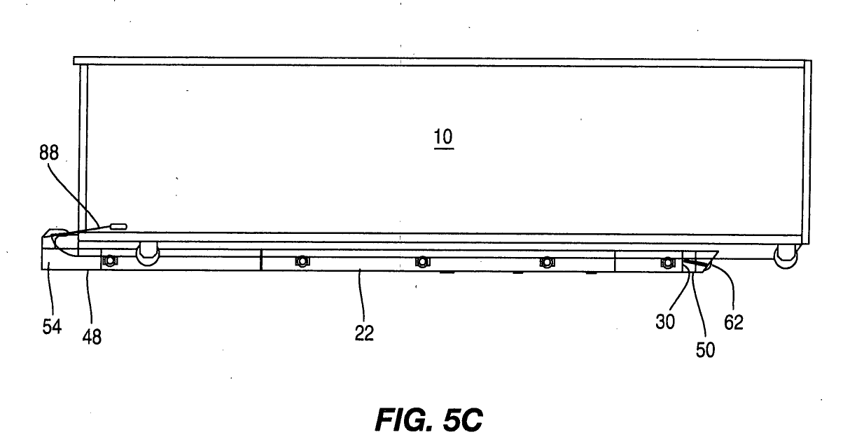

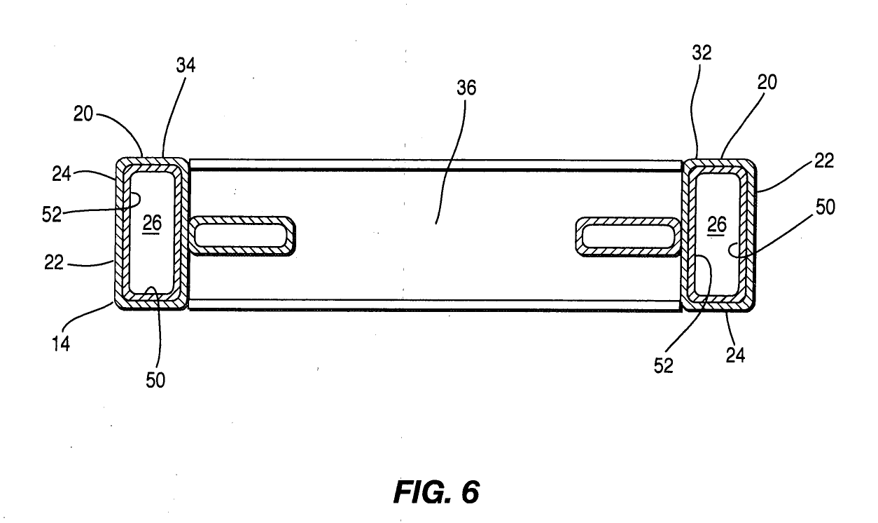

With the configuration where the movable tail section is movable with the movable frame section, then the movable frame section 50 will be slidable longitudinally with respect to the stationary frame section 22 between a tail extended position 60 extended to the full degree of movement to the right as shown in FIG. 1A and movable completely to the left to the tail retracted position 62 as shown in FIG. 5A.

The shoe member 64 will be slidable along a shoe movement path 72 defined between the shoe starting position 66 as defined in FIG. 1A and the shoe final position 68 as shown in FIG. 5A. A shoe intermediate position 70 will be defined along the shoe movement path 72 between the shoe starting position 66 and the shoe final position 68. This shoe intermediate position 70 will be the point at which the shoe member 64 initiates longitudinal movement of the movable frame section 50 with respect to the stationary frame section 22 shown longitudinally to the left as shown in FIG. 1A.

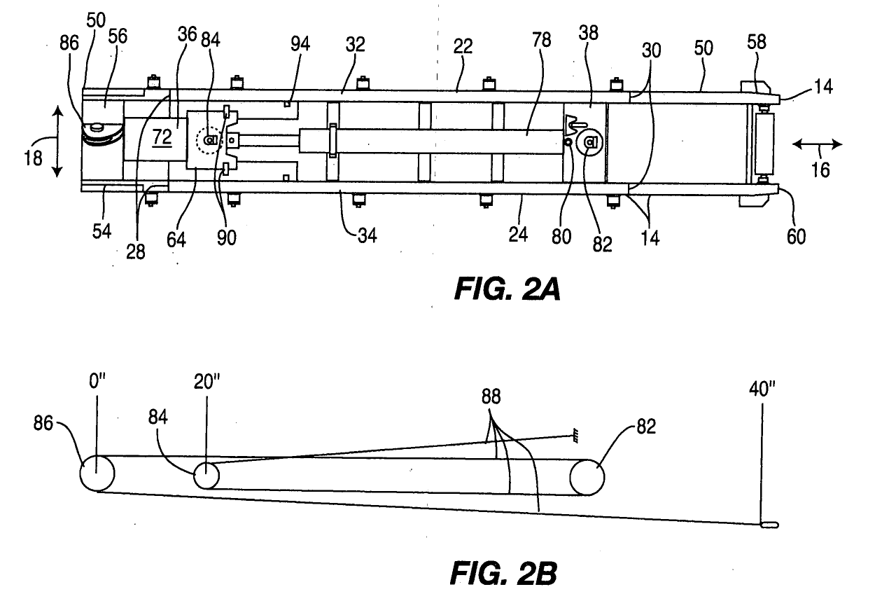

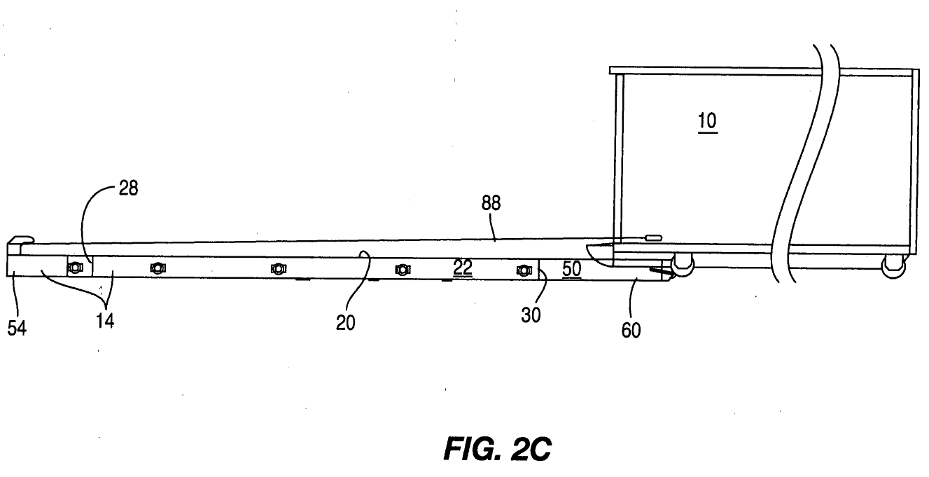

The present invention further includes a longitudinally extensible member such as an hydraulic cylinder 78 which is preferably pivotally secured with respect to the base crossmember 38. In this embodiment the cylinder 78 is shown movable to the left initially in the position shown in FIG. 1A through the four subsequent positions extending further and further to the left as shown in FIGS. 2A, 3A, 4A and 5A. Also the cylinder 78 can move to the right to return to the initial position shown in FIG. 1A from the FIG. 5A position.

A shoe sheave 84 is preferably rotatably mounted upon the shoe member 64. A frontal sheave 86 is rotatably mounted on the frontal crossmember 56.

A flexible line 88 such as a metallic cable is secured to the frame 14 at a frame securement point 98. The flexible cable 88 will extend from the point of securement 98 with respect to the frame 14 around the shoe sheave 84 and then rearwardly to extend around the base sheave 82 and then forwardly to extend around the frontal sheave 86 and finally extend rearwardly to a point of attachment with respect to the container. It is necessary that the line with respect to the container be detachable such as by a hook mechanism or other similar easily detachable but firmly securable means.

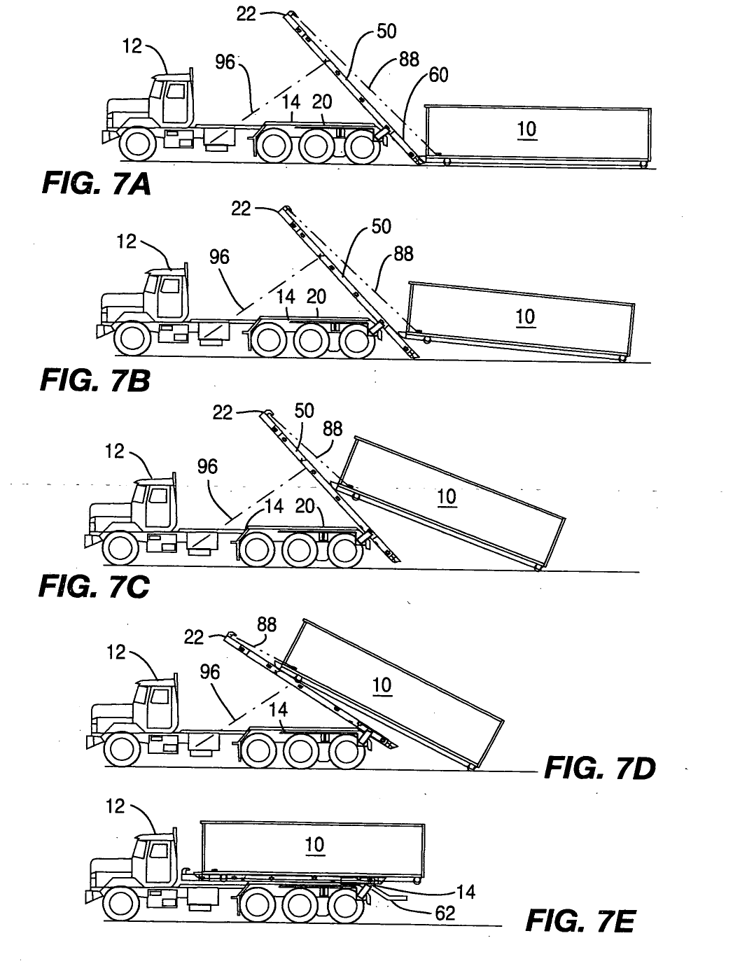

The operation of the apparatus of the present invention is best understood by first considering the sequence of FIGS. 7A, 7B, 7C, 7D and 7E. FIG. 7A shows the operation of a frame tilting means 96 such as a rearwardly and upwardly directed cylinder which can tilt the entire apparatus of the present invention to be inclined extending downwardly rearwardly as shown in FIG. 7A. In this position preferably the entire frame 14 will be inclined downwardly and rearwardly and the movable tail section 58 will be moved to the tail extended position 60 such as to be capable of contacting the ground or street surface immediately behind the roll-off vehicle 12. The cable means 88 is then attached to the container 10 and movement is initiated by retracting of the cable. FIG. 7B shows the container 10 partially lifted by the apparatus of the present invention and leaning against the movable tail section 58 which is in the tail extended position 60. FIG. 7C shows the point at which the container 10 is approximately halfway loaded onto the upper support surface 20 of the frame 14. In FIG. 7D the container 10 is almost completely loaded and the frame tilting means 96 is starting to contract downwardly to pivot the front end of frame 14 toward the horizontal position. In FIG. 7E the frame tilting means 96 has been completely contracted to allow the frame 14 to assume the horizontal position and to allow the container 10 to be drawn to the storage position upon the upper support surface 20 as the movable tail section 58 completes its movement from the tail extended position 60 to the tail retracted position 62. Unloading of a trailer is achieved by a reversal of the steps shown in FIGS. 7A through 7E.

The operation of the apparatus of the present invention is best shown by viewing FIGS. 1-5. There we see the actual operation of the loading and unloading apparatus of the present invention. The initial position is shown in FIGS. 1A, 1B and 1C wherein the movable frame section 50 is moved completely to the right as shown in FIG. 1A such that the movable tail section 58 is positioned in the tail extended position 60 in its point of greatest movement to the right. Here we see that the shoe member 64 is in the shoe starting position 66.

Loading of the container 10 with respect to the upper support surface 20 is achieved by initiating longitudinal extension of the hydraulic cylinder 78 to the left as shown in FIG. 2A, 2B and 2C. Since the longitudinally extendible member 78 is connected at one end to the base crossmember 38 and at the other end to the shoe member 64 movement of the shoe toward the left as shown in FIG. 2A, 2B and 2C will be initiated.

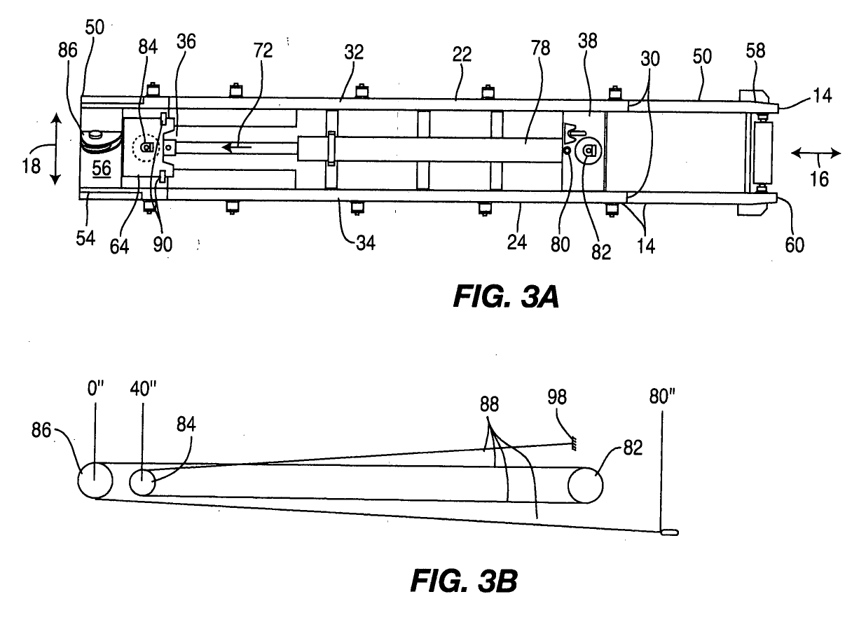

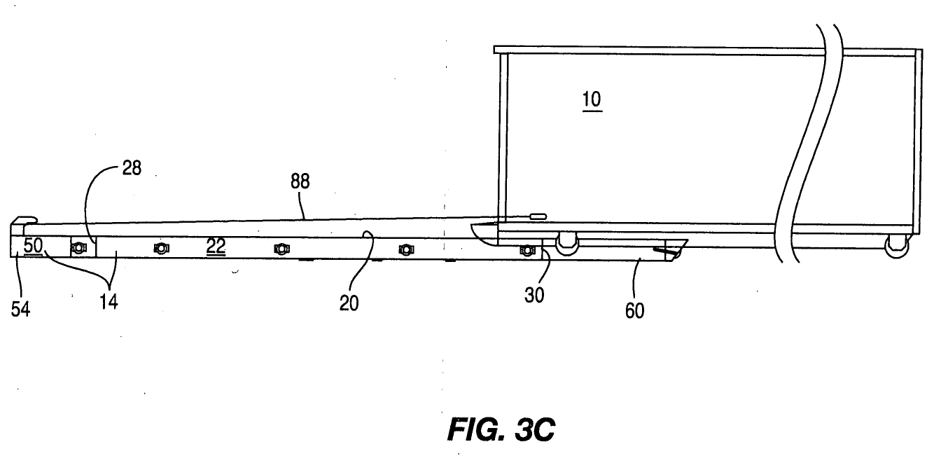

After further movement to the left of shoe member 64 is achieved by further time of operation of the hydraulic cylinder 78 the shoe member 64 will be moved to the intermediate position shown in FIG. 3A. At this intermediate position the shoe member 64 will come into abutting contact with respect to the movable frontal section 54 of the movable frame section 50. Any further movement of the shoe to the left after the position shown in FIG. 3A will cause similar movement to the left of the movable frame section 50 and also the movable frontal section 54 thereof to the left because of the abutting engagement of the shoe member 64 with respect thereto.

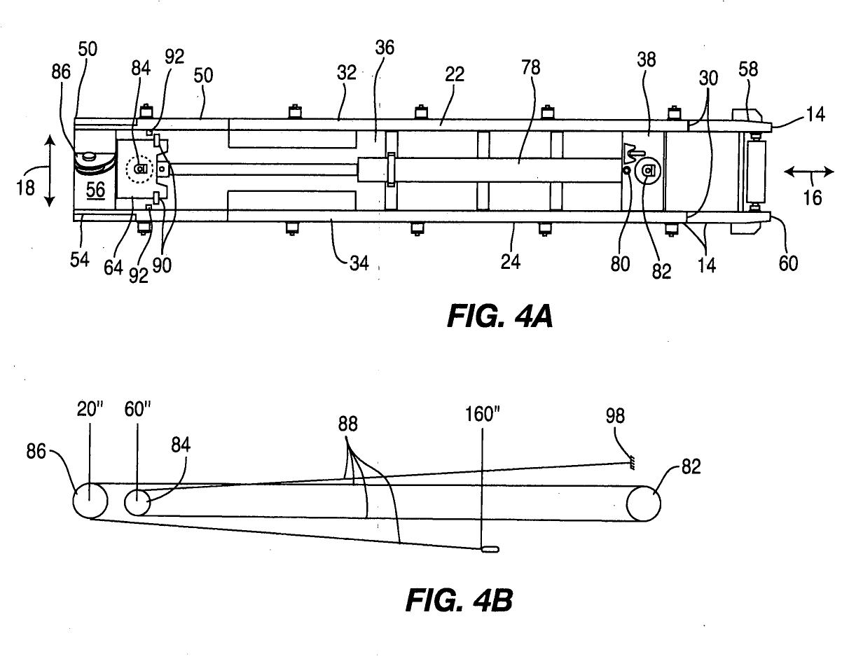

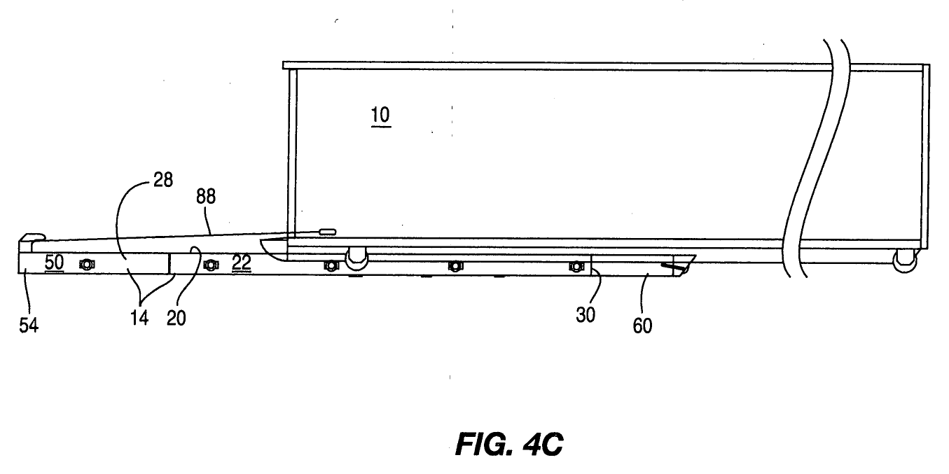

FIGS. 4A, 4B and 4C show the position of the apparatus of the present invention after some distance of further movement to the left of the shoe member 64 and the movable frame section 50 from the intermediate position shown in FIG. 3A.

As the longitudinally extendible hydraulic cylinder 78 powers movement of the shoe member 64 similar further movement to the left while in abutment with the shoe will be urged upon the movable frame section 50 and, in particular, the movable frontal section 54 thereof.

Finally the shoe member 64 will reach the shoe final position 68 extended completely to the left by further longitudinal extension of the hydraulic cylinder 78 to the left. Once the shoe member 64 reaches the shoe final position 68 the movable frame section 50 will be moved completely to the leftmost possible position as shown in FIG. 5A with a resulting movement of the movable tail section 58 completely to the tail retracted position 62.

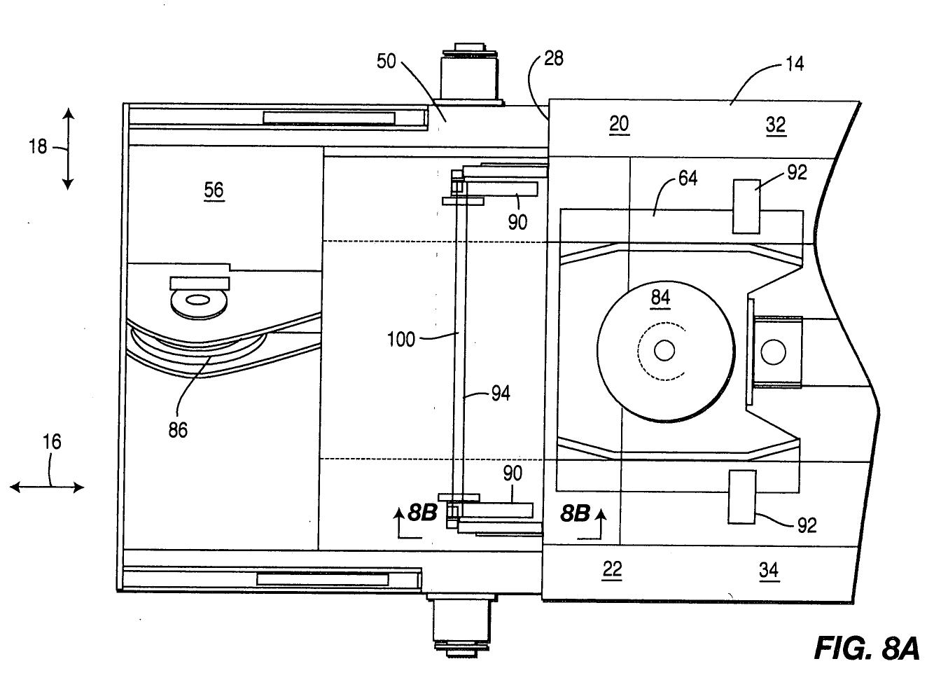

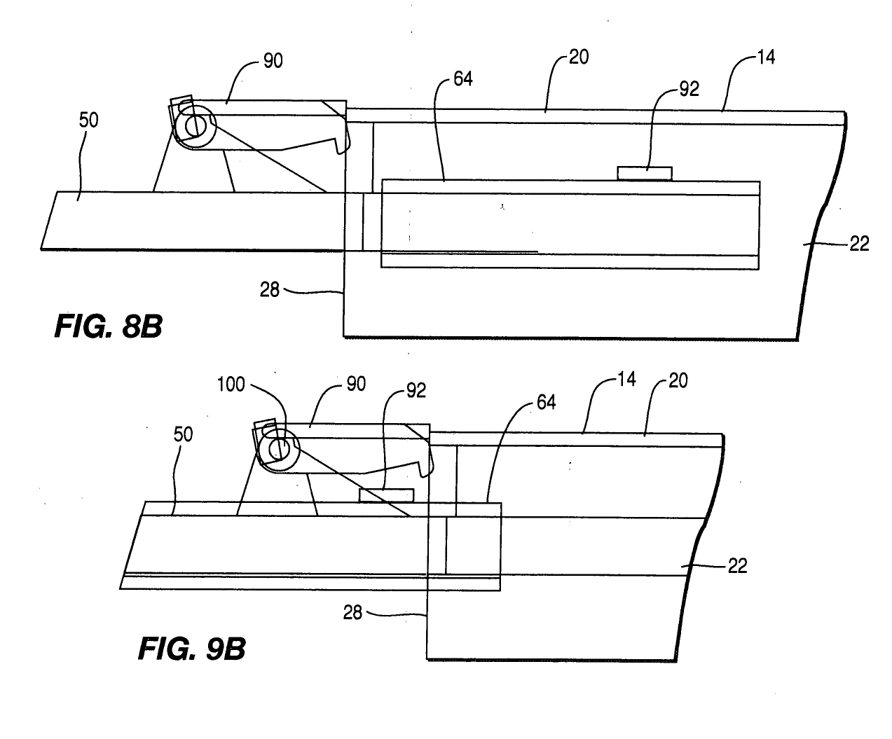

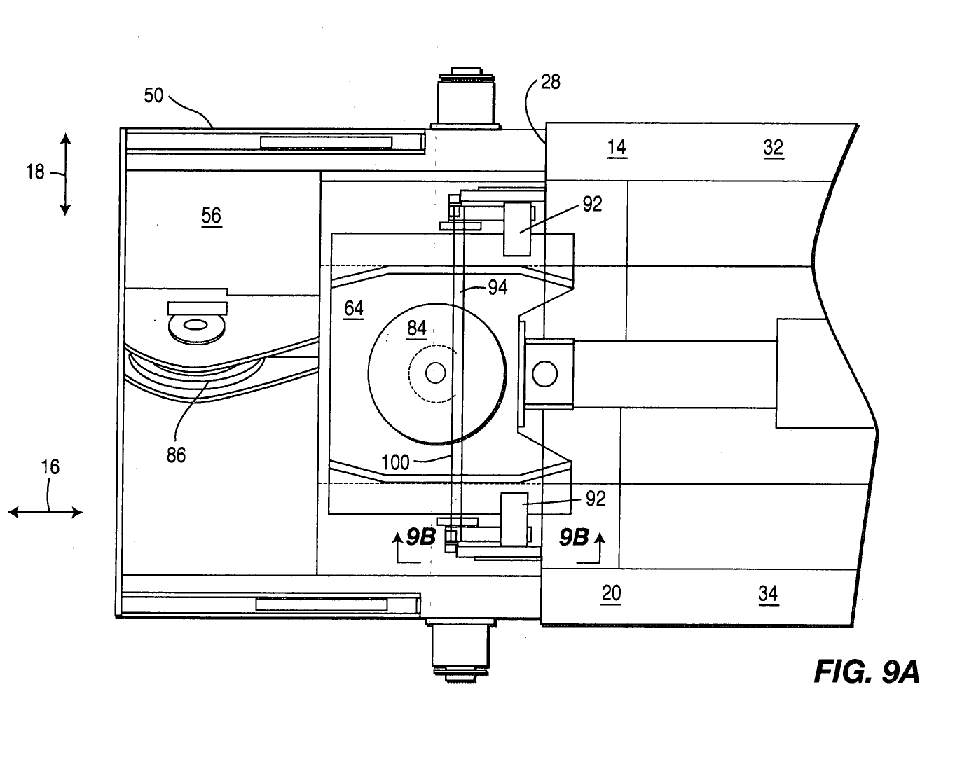

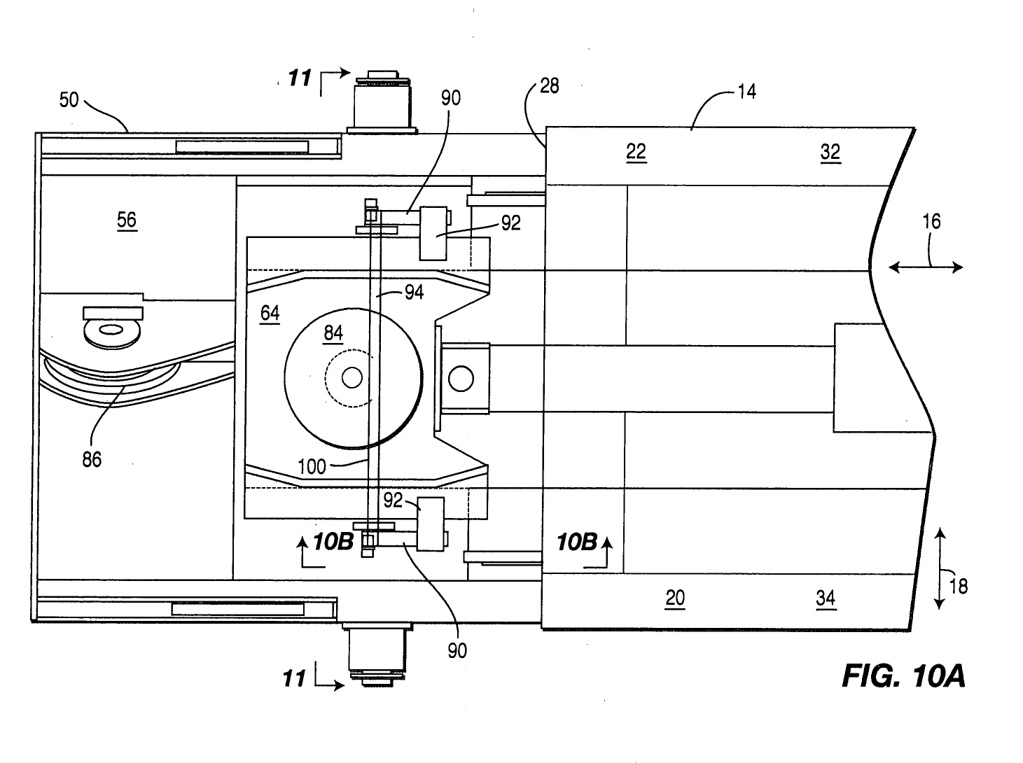

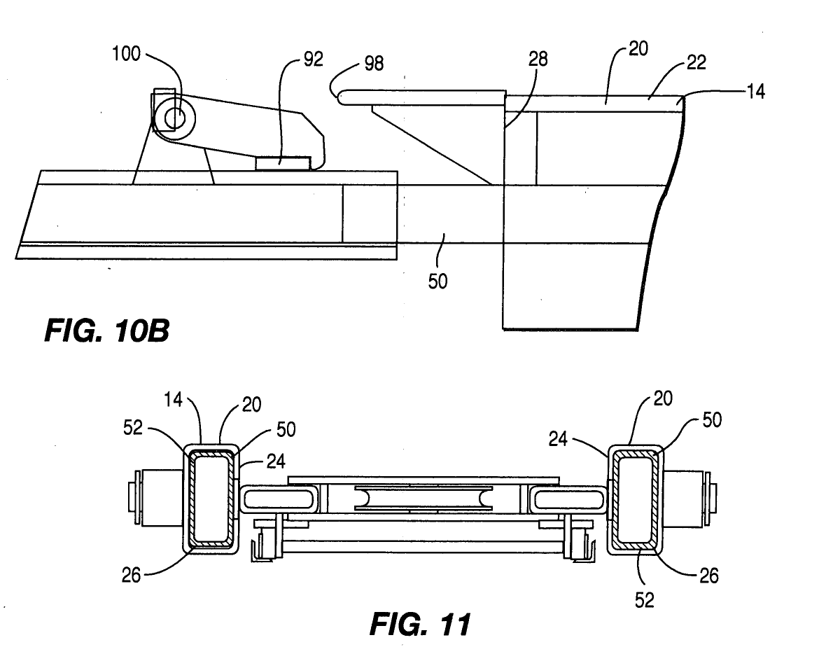

When the shoe member 64 reaches the shoe final position 68 a locking means 90 which is carried upon the shoe member 64 will engage a lock engagement means 92 mounted on the movable frame section 50. This locking engagement will maintain abutting engagement between the shoe member 64 and the movable frontal section 54 of movable frame section 50 as the hydraulic cylinder 78 initiates longitudinal retraction. After the position of FIG. 5A is reached the container will be fully loaded upon the upper support surface 20. Thereafter the container 10 is held in position for transport or other processing. The sequence of locking is shown by FIGS. 8A and 8B which shows the locking mechanism moving toward one another followed by FIGS. 9A and 9B showing the locking mechanism about to engage with one another. Finally the engaged locking mechanism is shown by FIGS. 10A and 10B. Unlocking is achieved by reverse operation sequencing from FIGS. 10A and 10B to 9A and 9B and finally to 8A and 8B for full disengagement.

When it is necessary to release the container the longitudinally extensible member 78 will retract to the right from the position shown in FIG. 1. As it retracts it will also cause movement of the movable frame section 50 to the right because of the engagement of the locking means 90 and the lock engagement means 92. The hydraulic cylinder 78 will retract until the shoe member 64 reaches the shoe starting position 66 at which point the locking means 90 will engage the lock disengagement means 94 causing release of locking means 90. At this point the apparatus will be again ready for the loading of a container.

The operation and coordination of movement of the container relative to the movement of the shoe member 64 is achieved by the plurality of sheaves defined in the present invention and the flexible cable 88. Preferably flexible cable 88 will be secured to the container and will then extend around the frontal sheave 86 fixedly secured with respect to the frontal crossmember 56. Thereafter the line will extend rearwardly around the base sheave 82 rotatably mounted to the base crossmember 38 and then forwardly around the shoe sheave 84 and finally to a point of fixed securement with respect to the vehicle 12 or frame 14.

As such, with this configuration with the powering of movement by the hydraulic cylinder 78 of the shoe member 64 to the left as shown in FIGS. 1-5, the line attached to the container will draw to the left as shown in FIGS. 1B, 2B, 3B, 4B and 5B. As the shoe member 64 moves further to the left toward the shoe final position 68 the container will be drawn to a position for support upon the upper support surface 20.

In the preferred configuration of the present invention the abutment between the shoe member 64 and the movable frontal section 54 of movable frame section 50 will be achieved by having direct abutment between shoe member 64 and the frontal crossmember 56. With the front crossmember 56 extending laterally across the movable frame section 50 engagement of the shoe member 64 therewith greatly facilitates operation of loading with the apparatus of the present invention. FIGS. 1C, 2C and 3C show the initial stages of loading with the frame means oriented horizontally. In most manner of operation, however, the apparatus of the present invention will be operating at those positions and during those stages of operation at an incline as shown in FIGS. 7A through 7C to facilitate upward movement of the container 10 to ease movement thereof toward the upper support surface 20.

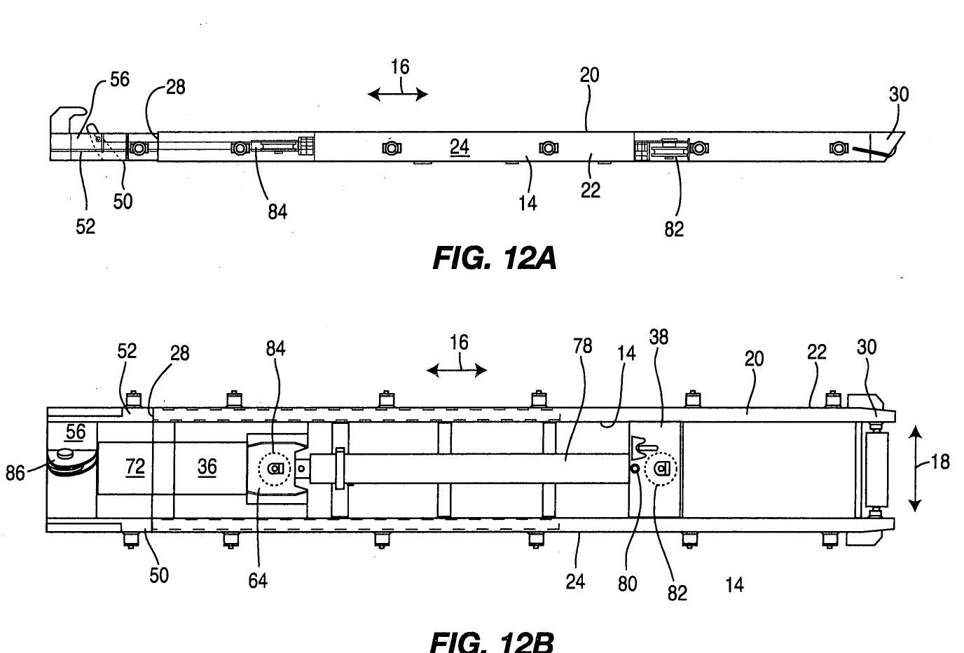

An alternative embodiment of the present invention is shown in FIGS. 12A and 12B. This design includes a movable frame section 50 which includes an inner tubular means 52 movable with respect to the stationary frame section 22. In this configuration the movable frame section 50 only includes the movable front section 54 and does not include any movable tail section. The movable frame section 54 terminates within the outer tubular channel 26 of the outer tubular means 24 of the stationary frame 22 and operates similar to the operation described hereabove for the other configurations. However, it does not include an integrally connected tail section. This design utilizing only the movable front section 54 for the movable frame section 50 can be used with a conventionally fixed tail frame or can be utilized with a movable tail frame alternatively. These are both conventional tail designs usable with the movable front section 54 shown in FIGS. 12A and 12B. The movable front section is powered again by longitudinal extension of the hydraulic cylinder 78 with corresponding movement of the shoe member 64. Shoe member 64 will drive outwardly to be brought into abutment with the frontal crossmember 56 to cause movement thereof in the longitudinal direction 16 away from the stationary frame section 22. A means for locking as shown in the previously described drawings will secure the shoe member 64 with respect to the frontal crossmember 56 such that as the hydraulic cylinder 78 is contracted both shoe 64 and crossmember 56 will move to the right as shown in FIG. 12B and return the movable frontal section 54 to the initial starting position thereof. As such, the only difference between the manner of operation of the alternative configuration shown in FIGS. 12A and 12B when compared to the other embodiments is in the omission of a tail section which is integrally formed or fixedly attached with respect to the movable frontal section 54.

While particular embodiments of this invention have been shown in the drawings and described above, it will be apparent, that many changes may be made in the form, arrangement and positioning of the various elements of the combination. In consideration thereof it should be understood that preferred embodiments of this invention disclosed herein are intended to be illustrative only and not intended to limit the scope of the invention.

We claim:

1. An apparatus for facilitating loading and unloading of a container upon a roll-off vehicle having a slidable frame section, said apparatus comprising:
A. a frame means comprising:
(1) a stationary frame section mounted with respect to a roll-off vehicle and defining an upper support surface for receiving of a container thereupon, said stationary frame section including:
a. a stationary front end;
b. a stationary tail end located longitudinally distant from said stationary front end;
c. a base crossmember mounted on said stationary frame section and extending laterally thereacross at a position between said stationary front end and said stationary tail end thereof;
(2) a movable frame section slidably engaged with respect to said stationary frame section to be movable therealong longitudinally, said movable frame section including a movable frontal section including a frontal crossmember extending laterally thereacross at a position spatially disposed longitudinally forwardly from said base crossmember, said movable frame section being slidably movable with respect to said stationary frame section between a rear position and a front position;
B. a shoe member movably engaged with respect to said stationary frame section and with respect to said movable frame section, said shoe member being movable longitudinally between a shoe starting position and a shoe final position spatially disposed longitudinally with respect to one another and defining a shoe movement path therebetween;
C. a longitudinally extensible member attached to said base crossmember and extensible outwardly therefrom longitudinally along said main frame means, said longitudinally extensible member also being attached with respect to said shoe member and operative to urge movement thereof longitudinally with respect to said main frame means in a direction away from said base crossmember to an intermediate abutment position in abutting engagement with respect to said movable front section of said movable frame section and being further movable longitudinally therealong while in engagement therewith to urge movement of said movable frame section from said rear position to said front position while simultaneously pulling of a container onto said upper support surface;
D. a base sheave means rotatably mounted with respect to said base crossmember;
E. a shoe sheave means rotatably mounted with respect to said shoe member and movable therewith along said shoe movement path between said shoe starting position and said shoe final position;
F. a frontal sheave means rotatably mounted with respect to said frontal crossmember and being movable therewith; and
G. a flexible line means secured to said frame means and extending outwardly therefrom around said shoe sheave means and then around said base sheave means and then around said frontal sheave means and then attached to a container to facilitate loading thereof upon said upper support surface of a roll-off vehicle.

2. An apparatus for facilitating loading and unloading of a container upon a roll-off vehicle having a slidable frame section as defined in claim 1 wherein said movable frame section further includes a movable tail section extendable outwardly from said stationary tail end of said stationary frame section oppositely oriented longitudinally from said movable frontal section, said movable frame section being movable between a tail extended position with said movable tail section extending rearwardly from said stationary frame section to facilitate loading of a container upon said upper support surface and a tail retracted position with said movable tail section retracted from the extending position.

3. An apparatus for facilitating loading and unloading of a container upon a roll-off vehicle having a slidable frame section as defined in claim 1 wherein said movable frontal section is extendable longitudinally outwardly from said stationary front end of said stationary frame section.

4. An apparatus for facilitating loading and unloading of a container upon a roll-off vehicle having a slidable frame section as defined in claim 1 wherein said intermediate abutment position is located within said shoe movement path between said shoe starting position and said shoe final position.

5. An apparatus for facilitating loading and unloading of a container upon a roll-off vehicle having a slidable frame section as defined in claim 1 wherein said longitudinally extensible member comprises an hydraulic cylinder means.

6. An apparatus for facilitating loading and unloading of a container upon a roll-off vehicle having a slidable frame section as defined in claim 5 wherein said hydraulic cylinder means is pivotally secured to said base crossmember to facilitate control of movement of said shoe member longitudinally along said frame means.

7. An apparatus for facilitating loading and unloading of a container upon a roll-off vehicle having a slidable frame section as defined in claim 1 wherein said movable frame section is in telescopingly movable engagement with respect to said stationary frame section in order to facilitate relative longitudinal movement of said movable frame section with respect thereto.

8. An apparatus for facilitating loading and unloading of a container upon a roll-off vehicle having a slidable frame section as defined in claim 7 wherein said stationary frame section includes outer tubular means defining outer tubular channel means extending longitudinally along said frame means and wherein said movable frame section includes inner tubular means adapted to extend into and through said outer tubular channel means of said outer tubular means to facilitate telescopingly longitudinal relative movement between said movable frame section and said stationary frame section.

9. An apparatus for facilitating loading and unloading of a container upon a roll-off vehicle having a slidable frame section as defined in claim 2 wherein said movable frame section is stationary with respect to said stationary frame section during movement of said shoe member from said shoe starting position to said shoe intermediate position and wherein said movable frame section moves from said tail extended position to said tail retracted position during movement of said shoe member from said shoe intermediate position to said shoe final position.

10. An apparatus for facilitating loading and unloading of a container upon a roll-off vehicle having a slidable frame section as defined in claim 1 wherein said flexible line means comprises a flexible metallic cable means to facilitate powering of movement of a container onto said upper support surface and to facilitate powering of movement of said movable frame means relative to said stationary frame means.

11. An apparatus for facilitating loading and unloading of a container upon a roll-off vehicle having a slidable frame section as defined in claim 1 further including locking means mounted on said movable frontal section of said movable frame section and further including lock engagement means mounted to said shoe member, said locking means and said lock engagement means adapted to interlock with respect to one another responsible to abutting engagement of said shoe member with respect to said frontal section of said movable frame section at said intermediate shoe position to selectively maintain abutting engagement of said shoe member with respect to said frontal section of said movable frame section.

12. An apparatus for facilitating loading and unloading of a container upon a roll-off vehicle having a slidable frame section as defined in claim 10 further including lock disengagement means operative to disengage said lock engagement means with respect to said locking means responsive to return movement of said shoe member to said shoe starting position.

13. An apparatus for facilitating loading and unloading of a container upon a roll-off vehicle having a slidable frame section as defined in claim 2 further comprising frame tilting means operative to tilt said frame means angled down rearwardly by lifting of said stationary front end of said stationary frame section and lifting of said movable frontal section of said movable frame section upwardly responsive to extension of said movable tail section of said movable frame section to said tail extended position to further facilitate loading of a container upon said upper support surface.

14. An apparatus for facilitating loading and unloading of a container upon a roll-off vehicle having a slidable frame section as defined in claim 1 wherein said shoe member and said frontal crossmember are in direct abutment with respect to one another responsive to said shoe member moving into said intermediate abutment position.

15. An apparatus for facilitating loading and unloading of a container upon a roll-off vehicle having a slidable frame section as defined in claim 1 wherein said movable frontal section of said movable frame section extends longitudinally forwardly from said stationary front end of said stationary frame section responsive to movement of said movable frame section to the front position thereof.

16. An apparatus for facilitating loading and unloading of a container upon a roll-off vehicle having a slidable frame section as defined in claim 2 wherein said movable tail section of said movable frame section extends longitudinally rearwardly from said stationary tail end of said stationary frame section during movement of said movable frame section between said tail extended position and said tail retracted position.

17. An apparatus for facilitating loading and unloading of a container upon a roll-off vehicle having a slidable frame section as defined in claim 2 wherein said movable frontal section of said movable frame section and said movable tail section of said movable frame section are integral and move together.

18. An apparatus for facilitating loading and unloading of a container upon a roll-off vehicle having a slidable frame section as defined in claim 1 wherein said stationary frame means includes:
A. a first stationary frame rail means extending longitudinally at least from said base crossmember to said frontal crossmember; and
B. a second stationary frame rail means also extending longitudinally at least from said base crossmember to said frontal crossmember and being spatially disposed laterally from said first frame rail means to define a shoe containment zone therebetween for retaining said shoe means therebetween during movement thereof along said shoe movement path.

19. An apparatus for facilitating loading and unloading of a container upon a roll-off vehicle having a slidable frame section as defined in claim 1 wherein said shoe containment zone is defined laterally between said first stationary frame rail means and said second stationary frame rail means and is defined longitudinally between said base crossmember and said frontal crossmember.

20. An apparatus for facilitating loading and unloading of a container upon a roll-off vehicle having a slidable frame section comprising:
A. a frame means comprising:
(1) a stationary frame section mounted with respect to a roll-off vehicle and defining an upper support surface for receiving of a container thereupon, said stationary frame section including:
a. a stationary front end;
b. a stationary tail end located longitudinally distant from said stationary front end;
c. a base crossmember mounted on said stationary frame section and extending laterally thereacross at a position between said stationary front end and said stationary tail end thereof;
(2) a movable frame section movably engaged with respect to said stationary frame section to be movable therealong longitudinally, said movable frame section including;
a. a movable frontal section including a frontal crossmember extending laterally thereacross at a position spatially disposed longitudinally forwardly from said base crossmember, said movable frontal section being extendable longitudinally outwardly from said stationary front end of said stationary frame section;
b. a movable tail section extendable outwardly from said stationary tail end of said stationary frame section oppositely oriented longitudinally from said movable frontal section;
said movable frame section being movable between a tail extended position with said movable tail section extending rearwardly from said stationary frame section to facilitate loading of a container upon said upper support surface and a tail retracted position with said movable tail section retracted from the extending position, said movable frontal section of said movable frame section adapted to extend longitudinally forwardly from said stationary front end of said stationary frame section during movement of said movable frame section between said tail extended position and said tail retracted position, said movable tail section of said movable frame section adapted to extend longitudinally rearwardly from said stationary tail end of said stationary frame section during movement of said movable frame section between said tail extended position and said tail retracted position, said movable frontal section of said movable frame section and said movable tail section of said movable frame section being configured integrally with respect to one another and move together;
B. a shoe member movably engaged with respect to said stationary frame section and with respect to said movable frame section, said shoe member being movable longitudinally between a shoe starting position and a shoe final position spatially disposed longitudinally with respect to one another and defining a shoe movement path therebetween;
C. a longitudinally extensible member comprising an hydraulic cylinder means attached to said base crossmember and extensible outwardly therefrom longitudinally along said main frame means, said longitudinally extensible member also being attached with respect to said shoe member and operative to urge movement thereof longitudinally with respect to said main frame means in a direction away from said base crossmember to an intermediate abutment position in abutting engagement with respect to said movable front section of said movable frame section and being further movable longitudinally therealong while in engagement therewith to urge movement of said movable frame section from said tail extended position to said tail retracted position while simultaneously pulling of a container onto said upper support surface, said intermediate abutment position being located within said shoe movement path between said shoe starting position and said shoe final position, said movable frame section being stationary with respect to said stationary frame section during movement of said shoe member from said shoe starting position to said shoe intermediate position and wherein said movable frame section moves from said tail extended position to said tail retracted position during movement of said shoe member from said shoe intermediate position to said shoe final position;
D. a base sheave means rotatably mounted with respect to said base crossmember;
E. a shoe sheave means rotatably mounted with respect to said shoe member and movable therewith along said shoe movement path between said shoe starting position and said shoe final position;
F. a frontal sheave means rotatably mounted with respect to said frontal crossmember and being movable therewith; and
G. a flexible metallic cable means secured to said frame means and extending outwardly therefrom around said shoe sheave means and then around said base sheave means and then around said frontal sheave means and then attached to a container to facilitate loading thereof upon said upper support surface of a roll-off vehicle.

21. An apparatus for facilitating loading and unloading of a container upon a roll-off vehicle having a slidable frame section comprising:
A. a frame means comprising:
(1) a stationary frame section mounted with respect to a roll-off vehicle and defining an upper support surface for receiving of a container thereupon, said stationary frame section including an outer tubular means defining outer tubular channel means extending longitudinally along said frame means, said stationary frame section including:
a. a stationary front end;
b. a stationary tail end located longitudinally distant from said stationary front end;
c. a base crossmember mounted on said stationary frame section and extending laterally thereacross at a position between said stationary front end and said stationary tail end thereof;
D. a first stationary frame rail means extending longitudinally at least from said stationary front end to said stationary tail end;
E. a second stationary frame rail means also extending longitudinally at least from said stationary front end to said stationary tail end and being spatially disposed laterally from said first frame rail means to define a shoe containment zone therebetween;
(2) a movable frame section movably engaged with respect to said stationary frame section to be movable therealong longitudinally, said movable frame section being in telescopingly movable engagement with respect to said stationary frame section in order to facilitate relative longitudinal movement of said movable frame section with respect thereto, said movable frame section including an inner tubular means adapted to extend into and through said outer tubular channel means of said outer tubular means to facilitate telescopingly longitudinal relative movement between said movable frame section and said stationary frame section, said movable frame section including;
a. a movable frontal section including a frontal crossmember extending laterally thereacross at a position spatially disposed longitudinally forwardly from said base crossmember, said movable frontal section being extendable longitudinally outwardly from said stationary front end of said stationary frame section;
b. a movable tail section extendable outwardly from said stationary tail end of said stationary frame section oppositely oriented longitudinally from said movable frontal section;
said movable frame section being movable between a tail extended position with said movable tail section extending rearwardly from said stationary frame section to facilitate loading of a container upon said upper support surface and a tail retracted position with said movable tail section retracted from the extending position, said movable frontal section of said movable frame section adapted to extend longitudinally forwardly from said stationary front end of said stationary frame section during movement of said movable frame section between said tail extended position and said tail retracted position, said movable tail section of said movable frame section adapted to extend longitudinally rearwardly from said stationary tail end of said stationary frame section during movement of said movable frame section between said tail extended position and said tail retracted position, said movable frontal section of said movable frame section and said movable tail section of said movable frame section being configured integrally with respect to one another and move together;
B. a shoe member movably engaged with respect to said stationary frame section and with respect to said movable frame section, said shoe member being movable longitudinally between a shoe starting position and a shoe final position spatially disposed longitudinally with respect to one another and defining a shoe movement path therebetween, said shoe containment zone being defined laterally between said first stationary frame rail means and said second stationary frame rail means and being defined longitudinally between said base crossmember and said frontal crossmember;
C. a longitudinally extensible member comprising an hydraulic cylinder means pivotally movably attached to said base crossmember and extensible outwardly therefrom longitudinally along said main frame means, said longitudinally extensible member also being attached with respect to said shoe member and operative to urge movement thereof longitudinally with respect to said main frame means in a direction away from said base crossmember to an intermediate abutment position in abutting engagement with respect to said movable front section of said movable frame section and being further movable longitudinally therealong while in engagement therewith to urge movement of said movable frame section from said tail extended position to said tail retracted position while simultaneously pulling of a container onto said upper support surface, said intermediate abutment position being located within said shoe movement path between said shoe starting position and said shoe final position, said movable frame section being stationary with respect to said stationary frame section during movement of said shoe member from said shoe starting position to said shoe intermediate position and wherein said movable frame section moves from said tail extended position to said tail retracted position during movement of said shoe member from said shoe intermediate position to said shoe final position, said shoe member and said frontal crossmember being in direct abutment with respect to one another responsive to said shoe member moving into said intermediate abutment position;
D. a base sheave means rotatably mounted with respect to said base crossmember;
E. a shoe sheave means rotatably mounted with respect to said shoe member and movable therewith along said shoe movement path between said shoe starting position and said shoe final position;
F. a frontal sheave means rotatably mounted with respect to said frontal crossmember and being movable therewith;
G. a flexible metallic cable means secured to said frame means and extending outwardly therefrom around said shoe sheave means and then around said base sheave means and then around said frontal sheave means and then attached to a container to facilitate loading thereof upon said upper support surface of a roll-off vehicle;
H. a locking means mounted on said movable frontal section of said movable frame section and further including a lock engagement means mounted to said shoe member, said locking means and said lock engagement means adapted to interlock with respect to one another responsible to abutting engagement of said shoe member with respect to said frontal section of said movable frame section at said intermediate shoe position to selectively maintain abutting engagement of said shoe member with respect to said frontal section of said movable frame section;
I. a lock disengagement means operative to disengage said lock engagement means with respect to said locking means responsive to return movement of said shoe member to said shoe starting position; and
J. a frame tilting means operative to tilt said frame means angled down rearwardly by lifting of said stationary front end of said stationary frame section and lifting of said movable frontal section of said movable frame section upwardly responsive to extension of said movable tail section of said movable frame section to said tail extended position to facilitate loading of a container upon said upper support surface.
